(19) United States
(12) Patent Application Publication
(10) Pub. No.: US 2022/0146377 A1
(43) Pub. Date: May 12, 2022

(54) FIBROUS MATERIAL SAMPLE CUTTER

(71) Applicant: Rethceif Enterprises, LLC, Ossian, IN (US)

(72) Inventors: Briar Lee Gerber, Fort Wayne, IN (US); Philip R. Beer, Craigville, IN (US); Jeremy Ray Collins, Bluffton, IN (US); Chris Alen Honegger, Bluffton, IN (US)

(21) Appl. No.: 17/508,278

(22) Filed: Oct. 22, 2021

Related U.S. Application Data
(60) Provisional application No. 63/110,558, filed on Nov. 6, 2020.

(51) Int. Cl. G01N 1/04

(52) U.S. Cl. CPC G01N 1/04; G01N 2001/061

(57) ABSTRACT

An exemplary sample cutter is provided for preparing a sample of fibrous material. The sample cutter generally includes a base plate and a cutting mechanism extending from the base plate. The cutting mechanism includes at least one blade and at least one discontinuity. The at least one discontinuity has a total length less than 10% of a total perimeter of the cutting mechanism.

### CROSS-REFERENCE TO RELATED APPLICATIONS

The present application claims the benefit of U.S. Provisional Patent Application No. 63/110,558, filed Nov. 6, 2020, the contents of which are incorporated by reference in their entirety.

### TECHNICAL FIELD

The present disclosure generally relates to sampling of fibrous materials, and more particularly but not exclusively relates to preparing samples of cotton from a bale.

### BACKGROUND

In order to evaluate the quality of certain fibrous materials, such as cotton, before sale, a sample of the material from each bale is provided to an evaluating agency, typically a division of the United States Department of Agriculture (USDA). This evaluation, called “grading,” allows a bale, such as cotton, to be sold to customers without the entire product being seen. Further, before large quantities of the fibrous materials are stored for later sale, samples of the material may be obtained to be provided to prospective customers for testing, rather than transporting an entire bale to the prospective customer. In addition to facilitating the testing of a larger amount of material, obtaining samples from bales before the bales are bagged or otherwise encased in a protective covering ensures that the integrity of such protective covering remains intact.

In certain conventional systems, a sample is formed during the pressing process using a sample cuter such as the sample cutter 90 illustrated in FIG. 1. This cutter is forced into the fibers, severing them from the cohesive, intertwined body of the bale. Since the sample will be removed, it is practical to cut the sample between the areas where bale retention straps are typically placed. The cut sample will typically bulge from the side of the bale when the pressing force is removed since it is not bound to its neighboring fibers contained by bale retention straps. The sample generally retains an “uncut” side across a top length after the sample is cut with the cutter to retain the sample on the bale.

As noted above, certain conventional approaches to obtaining a sample from a bale involve the use of the sample cutter 90 illustrated in FIG. 1. This sample cutter 90 includes a plurality of discrete cutting edges 92 that generally form three sides of a rectangle, with the fourth side of the rectangle and the corners of the rectangle being absent. Such sample cutters thus leave one full side of the rectangle and each of the corners intact on the bale, which may make it difficult to fully remove the sample from the bale without the use of an additional cutting instrument, such as scissors or a knife. For these reasons among others, there remains a need for further improvements in this technological field.

### SUMMARY

An exemplary sample cutter is provided for preparing a sample of fibrous material. The sample cutter generally includes a base plate and a cutting mechanism extending from the base plate. The cutting mechanism includes at least one blade and at least one discontinuity. The at least one discontinuity has a total length less than 10% of a total perimeter of the cutting mechanism. Further embodiments, forms, features, and aspects of the present application shall become apparent from the description and figures provided herewith.

### BRIEF DESCRIPTION OF THE FIGURES

FIG. 1 is a perspective illustration of a conventional sample cutter.

FIG. 2 is a perspective illustration of a sample cutter according to certain embodiments.

FIG. 3 is a plan view of the sample cutter illustrated in FIG. 2.

FIG. 4 is a first cross-sectional illustration of the sample cutter illustrated in FIG. 2, taken along the line IV-IV in FIG. 3.

FIG. 5 is a second cross-sectional illustration of the sample cutter illustrated in FIG. 2, taken along the line V-V in FIG. 3.

FIG. 6 is a schematic representation of a system according to certain embodiments.

FIG. 7 is a perspective view of a mass of fibrous material having a sample prepared using the sample cutter illustrated in FIGS. 2-5.

FIG. 8 is a plan view of the mass of fibrous material illustrated in FIG. 7.

FIG. 9 is a schematic flow diagram of a process according to certain embodiments.

FIGS. 10-16 are plan views of sample cutters according to certain embodiments.

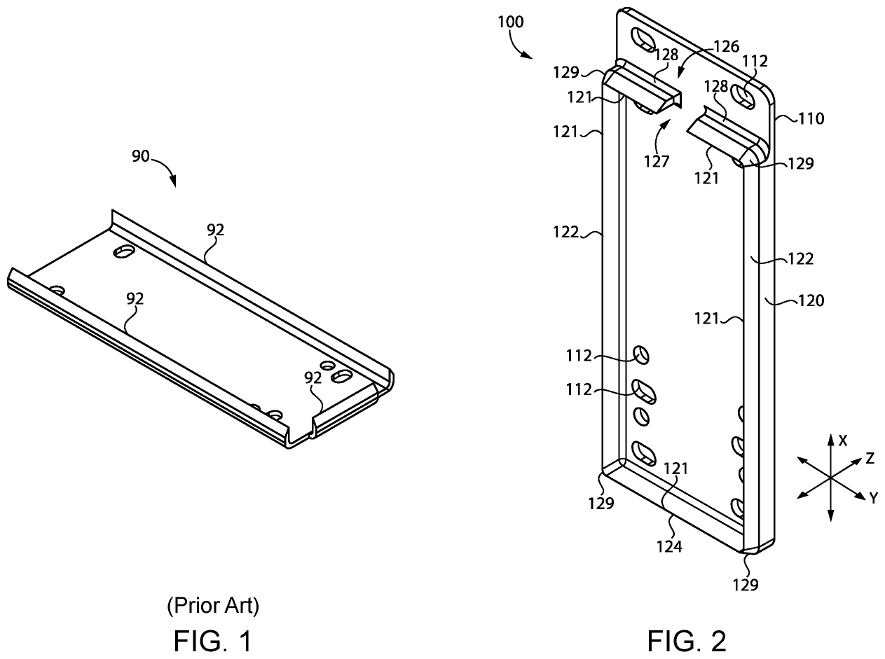

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the terms “longitudinal,” “lateral,” and “transverse” are used to denote motion or spacing along three mutually perpendicular axes, wherein each of the axes defines two opposite directions. In the coordinate system illustrated in FIG. 2, the X-axis defines first and second longitudinal directions, the Y-axis defines first and second lateral directions, and the Z-axis defines first and second transverse directions. These terms are used for ease and convenience of description, and are without regard to the orientation of the system with respect to the environment. For example, descriptions that reference a longitudinal direction may be equally applicable to a vertical direction, a horizontal direction, or an off-axis orientation with respect to the environment.

Furthermore, motion or spacing along a direction defined by one of the axes need not preclude motion or spacing along a direction defined by another of the axes. For example, elements that are described as being “laterally offset” from one another may also be offset in the longitudinal and/or transverse directions, or may be aligned in the longitudinal and/or transverse directions. The terms are therefore not to be construed as limiting the scope of the subject matter described herein to any particular arrangement unless specified to the contrary.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

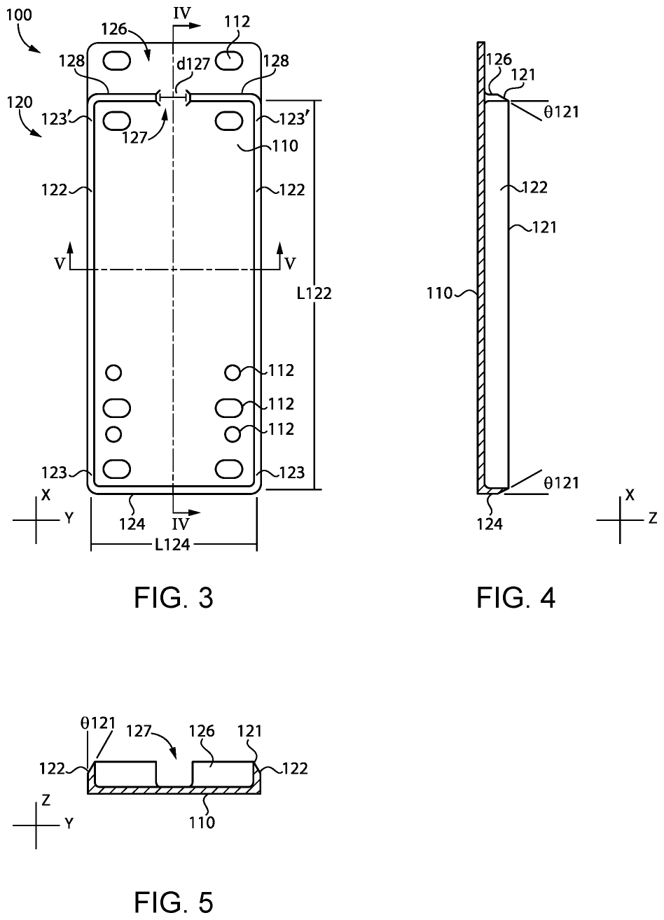

With reference to FIG. 2-5, illustrated therein is a sample cutter 100 according to certain embodiments. The sample cutter 100 generally includes a base plate 110 and a cutting mechanism 120 extending from the base plate 120. While other materials are contemplated, the sample cutter 100 may, for example, be formed of steel, such as a pre-hardened steel.

The base plate 110 is configured for coupling to a press by which a mass of fibrous material is compressed. The illustrated base plate 110 includes one or more mounting apertures 112 that may facilitate such coupling by fasteners such as screws. It is also contemplated that the base plate 110 may be secured to the press by other coupling mechanisms, such as magnets.

The cutting mechanism 120 extends from the base plate 110, and in the illustrated form defines a geometric shape. While other forms are contemplated, in the illustrated embodiment the geometric shape is a polygonal shape, and more particularly a generally rectangular shape. The cutting mechanism 120 includes at least one blade and at least one discontinuity. In the illustrated form, the cutting mechanism 120 includes a plurality of continuous blades and a discontinuous blade. More particularly, the illustrated cutting mechanism 120 includes two longitudinally-extending continuous blades 122, a laterally-extending continuous blade 124, and a laterally-extending discontinuous blade 126 defining a discontinuity 127. In certain embodiments, the blades 122, 124, 126 may be considered to define a single continuous blade comprising the discontinuity 127.

In the illustrated form, the longitudinal blades 122 extend parallel to one another, and the lateral blades 124, 126 extend parallel to one another and meet the longitudinal blades 122 at corners 129, which in the illustrated form are rounded. More particularly, the longitudinal blades 122 have first ends 123 and second ends 123′, the first lateral blade 124 extends between the first ends 123, and the second lateral blade 126 extends between the second ends 123′. It is also contemplated that one or both of the lateral blades 124, 126 may not necessarily reach one or more of the longitudinal blades 122, in which case one or more of the corners 129 may be omitted. In such forms, the lateral ends of the lateral blades 124, 126 may be longitudinally and/or laterally offset from the longitudinal ends 123, 123′ of the longitudinal blades 122.

Each blade of the cutting mechanism 120 includes a corresponding and respective cutting edge 121 configured to cut the fibrous material when the sample cutter 100 is pressed into the mass of fibrous material. The cutting edge 121 defines an angle θ121 appropriate for cutting the fibrous material. While other angles are contemplated, the illustrated angle θ121 is about 30°. It is also contemplated that the edge angle θ121 may be between about 25° and 35°, between 20° and 40°, or within another angular range.

As noted above, the illustrated cutting mechanism 120 is generally in the shape of a rectangle. It is also contemplated that the cutting mechanism 120 may have another geometry, such as that of a circle, an ellipse, or a polygon other than a rectangle. By way of example, the cutting mechanism 120 may have the shape of an N-gon having N sides and N vertices, wherein each side is defined by a corresponding blade and at least one of the blades comprises a discontinuity. In certain forms, the cutting mechanism 120 may comprise exactly one discontinuity such that N-1 of the sides of the N-gon are continuous sides and one of the sides is a discontinuous side. In certain embodiments, each of the blades meets an adjacent blade at a corner corresponding to one of the vertices of the N-gon. In certain embodiments, one or more of the blades may not necessarily meet an adjacent blade such that one or more vertices of the N-gon does not correspond to a corner of the cutting mechanism 120.

Each side of the rectangle defined by the illustrated cutting mechanism 120 has a corresponding and respective length dimension. For example, the longitudinal blades 122 have a longitudinal length dimension L122 and the lateral blades 124, 126 have a lateral length dimension L124. Additionally, the discontinuity 127 has a discontinuity length dimension d127 that is less than each of the length dimensions L122, L124. In embodiments in which the shape defined by the cutting mechanism 120 is an N-gon, each side of the N-gon may have a corresponding and respective side length, and the length dimension d127 of the discontinuity 127 may be less than each of the side lengths. Additionally or alternatively, the length dimension d127 of the discontinuity may be less than a maximum dimension of cutting mechanism in a direction parallel to the discontinuity dimension d127. While other dimensions are contemplated, in the illustrated form, the longitudinal length dimension L122 is about 11.5 inches, the lateral dimension L124 is about five inches, and the discontinuity dimension d127 is about one inch (e.g., between 0.5 inches and 1.5 inches, or between 0.75 inches and 1.25 inches). As such, the total perimeter of the cutting mechanism is about 33 inches.

In embodiments in which the shape defined by the cutting mechanism 120 is a generally polygonal shape, the discontinuity dimension d127 and the length of the discontinuous blade in which the discontinuity 127 is formed may have a predetermined aspect ratio that is less than one such that the discontinuity dimension d127 is less than the length of the side of the polygon. In certain embodiments, the aspect ratio may be less than 50%. In the illustrated form, the aspect ratio is about 25% (e.g., between 20% and 30%) such that the discontinuity dimension d127 is about one quarter the lateral dimension L124. It is also contemplated that higher and lower aspect ratios may be selected. In certain embodiments, such as those in which the polygon comprises five or more sides, the aspect ratio may be equal to one.

In certain embodiments, the discontinuity dimension d127 may be selected based upon the total perimeter of the geometric shape that is defined by the cutting mechanism 120. For example, the perimeter of the illustrated cutting mechanism comprises twice the longitudinal length L122 and twice the lateral length L124, for a total of about 33 inches, and the discontinuity dimension d127 is about one inch. In various forms, the discontinuity dimension may be less than 15% of the total perimeter, less than 10% of the total perimeter, or less than 5% of the total perimeter.

In embodiments in which the geometric shape defined by the cutting mechanism 120 is a circle or ellipse, the discontinuity 127 may define a central angle within a predetermined range bounded by a minimum central angle and a maximum central angle. In certain embodiments, the minimum central angle may be about 10°, about 15°, or about 20°. In certain embodiments, the maximum central angle may be about 20°, about 25°, or about 30°.

In the illustrated form, the discontinuity 127 is defined as a gap in the discontinuous lateral blade 126 such that the second lateral blade 126 comprises a pair of discontinuous blade portions 128 that are not connected to one another. It is also contemplated that the discontinuity 127 may be formed only in the cutting edge 121 of the second lateral blade 126 such that a base portion of the second lateral blade 126 connects the blade portions 128.

In the illustrated embodiment, the discontinuity 127 is defined at a center of the second lateral blade 126 such that the blade portions 128 are mirror images of one another. It is also contemplated that the discontinuity 127 may be formed elsewhere along the second lateral blade 126. For example, the discontinuity 127 may be formed at or adjacent a corner of the polygonal shape.

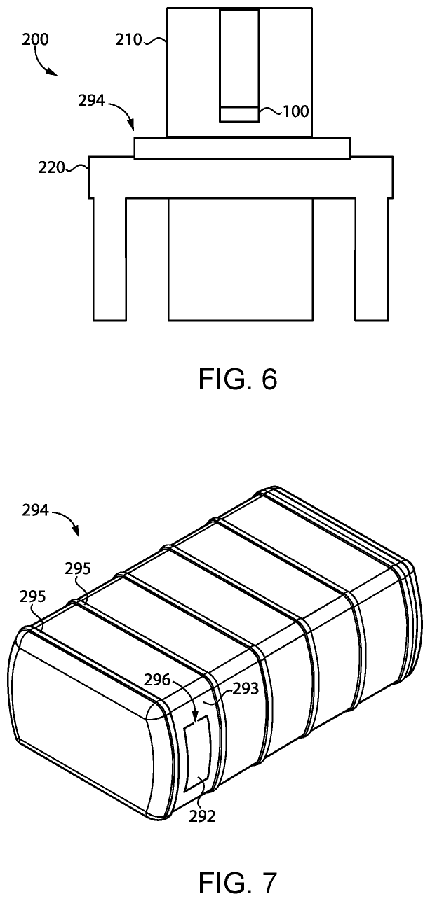

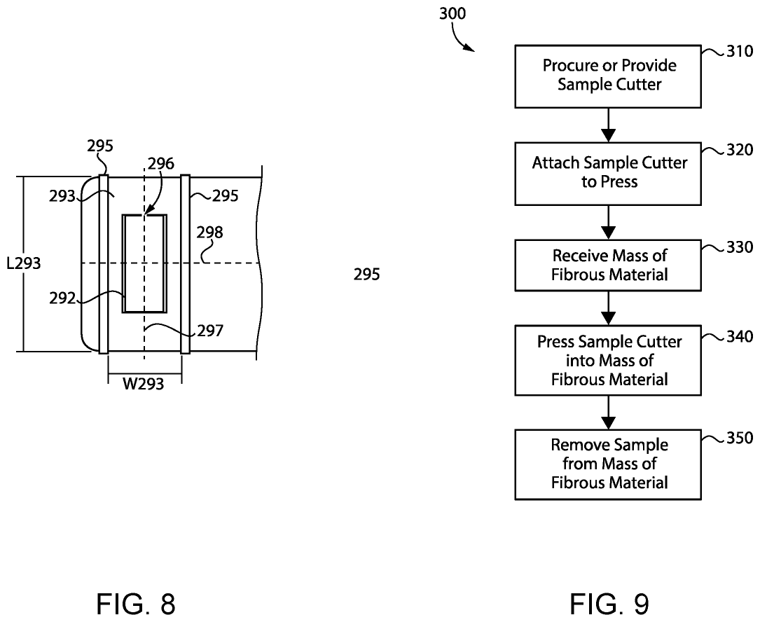

With additional reference to FIGS. 6-8, a system 200 according to certain embodiments is configured to prepare a sample 292 from a mass 294 of fibrous material. For example, the mass 294 of fibrous material may take the form of a sheet or bale, and the fibrous material may be cotton. The system 200 generally includes a press 210 to which the sample cutter 100 is mounted, for example using fasteners that extend through the apertures 112 of the base plate 110. The fibrous material mass 294 is positioned on a support 220 such as a table, and the press 210 is actuated to drive the sample cutter 100 into the fibrous material mass 294. The press 210 may be actuated pneumatically, hydraulically, electromechanically, or in another fashion.

As the sample cutter 100 is driven into the mass 294 of fibrous material, the cutting mechanism 120 cuts the fibrous material in locations that include the cutting edge 121. However, the sample cutter 100 does not cut the fibrous material in the location corresponding to the discontinuity 127. As such, the sample 292 remains connected to the fibrous material mass 294 at a connection area 296, which is formed at the location corresponding to the discontinuity 127. In certain embodiments, the sample 292 may be centered at the center of the face 293 in which the sample 292 is formed, with the face 293 being bound on two sides by the edges of the mass 294 and bound on two additional sides by bands 295 by which the mass 294 is held together. For example, the center of the sample 292 may be formed substantially along a centerline of the face 293 of the mass 294. In the illustrated form, the sample 292 is centered at an intersection of the two centerlines 297, 298 of the face 293 in which the sample 292 is formed. It is also contemplated that the sample 292 may be centered substantially along only one of the centerlines 297, 298. As one example, the sample 292 may be centered at the centerline 297 plus or minus 10% of the total width W293 of face 293. Additionally or alternatively, the sample 292 may be centered at the centerline 298 plus or minus 10% of the total length L293 of face 293.

In certain embodiments, the connection area 296 may be smaller than the connection areas that are formed by the conventional sample cutter 90, which may facilitate removal of the sample 292 from the fibrous material mass 294. The reduced size of the connection area 296 may be particularly advantageous in embodiments in which the sample 292 is to be removed from the fibrous material mass 294 using an air sampler, which removes the sample 292 from the fibrous material mass 294 using a burst of air. It should be appreciated, however, that the samples produced with the sample cutter 200 may be removed by methods other than air sampling, such as rakes, clamshells, and grippers.

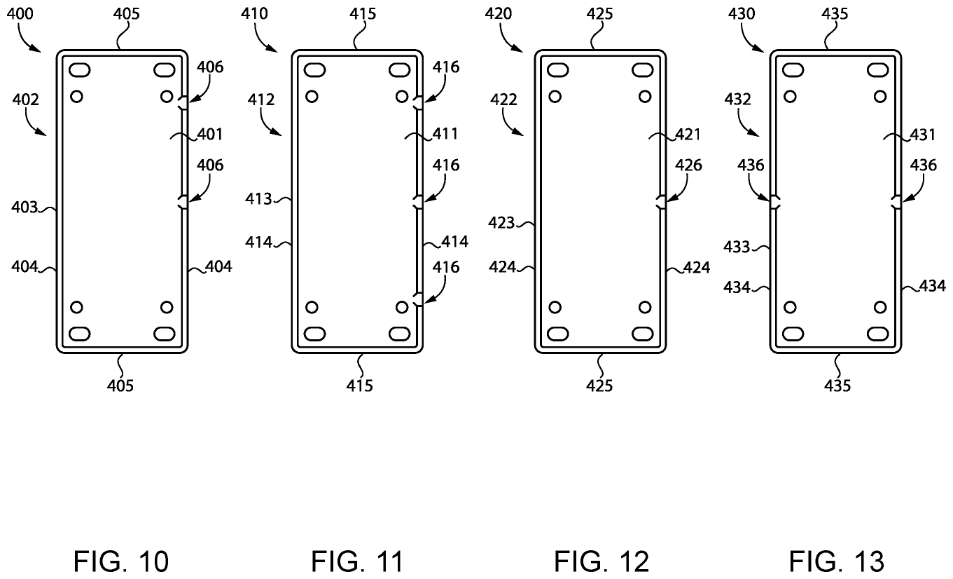

With additional reference to FIG. 9, an exemplary process 300 that may be performed using the sample cutter 100 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another. Moreover, while the process 300 is described herein with specific reference to the sample cutter 100 and associated system 200 illustrated in FIGS. 2-6, it is to be appreciated that the process 300 may be performed with sample cutters and/or sampling systems having additional or alternative features. Certain other sample cutters that may be utilized in the process 300 are described below with reference to FIGS. 10-16

The process 300 may begin with block 310, which generally involves procuring or providing a sample cutter including at least one blade. In certain embodiments, the at least one blade partially defines a geometric shape and has a discontinuity. In certain embodiments, the at least one blade defines exactly one discontinuity. In other embodiments, the blade defines a plurality of discontinuities. Block 310 may, for example, involve providing or procuring the sample cutter 100 illustrated in FIGS. 2-5, or one of the sample cutters illustrated in FIGS. 10-16.

The process 300 may include block 320, which generally involves securing the sample cutter to a press. For example, block 320 may involve securing the sample cutter 100 to the press 210. The press 210 may, for example, be provided as a pneumatic press, a hydraulic press, an electromechanical press, or another form of press.

The process 300 includes block 330, which generally involves receiving a mass of fibrous material. In certain embodiments, the fibrous material is cotton, and the mass is provided in the form of a sheet or bale. Block 330 may involve receiving the fibrous material mass 294 at an area in the vicinity of the press 210, for example on the support table 220.

The process 300 further includes block 340, which generally involves pressing the sample cutter into the mass of fibrous material to thereby prepare a sample from the mass of fibrous material. For example, block 340 may involve actuating the press 210 to drive the sample cutter 100 into the fibrous material mass 294 to thereby prepare the sample 292. As noted above, the sample 292 remains connected to the fibrous material mass 294 at a connection area 296 corresponding to the discontinuity 127. In certain embodiments, the connection area 296 may be formed substantially along a centerline of the face 293 of the mass 294 in which the sample 292 is formed. As one example, the connection area 296 may be formed at the centerline 297 plus or minus 10% of the total width W293 of face 293. Additionally or alternatively, the connection area 296 may be formed at the centerline 298 plus or minus 10% of the total length L293 of face 293.

In certain embodiments, the process 300 may further include block 350, which generally involves removing the sample from the mass of fibrous material. In certain embodiments, block 350 may involve manually removing the sample 292 from the fibrous material mass 294. In certain embodiments, block 350 may involve pneumatically removing the sample 292 from the mass 294 by directing a burst of air at the sample 292. As noted above, the smaller connection area 296 formed by the illustrated sample cutter 100 may facilitate the removal of the sample 292 using such a pneumatic sampler. As also noted above, it is also contemplated that the sample 292 may be removed by methods other than air sampling, such as rakes, clamshells, and grippers.

While an exemplary sample cutter 200 has been described and illustrated thus far, it is to be appreciated that other forms of sample cutters may be provided in accordance with other embodiments. For example, it has been found that for certain baling machines, a single connection area at the top of the sample may be insufficient, in that portions of the sample may disconnect or become snagged on surrounding machinery. In such cases, it may be advantageous to provide discontinuities in additional or alternative locations on the cutting mechanism. Certain examples of such sample cutters will now be described with reference to FIGS. 10-16.

With additional reference to FIGS. 10-16, illustrated therein are sample cutters according to additional embodiments. As described herein, each of the illustrated sample cutters includes a base plate, and a cutting device extending from the base plate. Each cutting device includes a pair of longitudinally-extending sides and a pair of laterally-extending sides, and at least one discontinuity, and the total length of the at least one discontinuity is less than 10% of the total perimeter of the cutting device.

FIG. 10 illustrates a sample cutter 400 according to certain embodiments. The sample cutter 400 includes a base plate 401 and a cutting device 402 extending from the base plate 401. The cutting device 402 includes at least one blade 403, the at least one blade 403 defining a pair of longitudinally-extending sides 404 and a pair of laterally-extending sides 405. At least one discontinuity 406 is formed in the cutting device 402, and in the illustrated form two discontinuities 406 are formed in one of the longitudinally-extending sides 404. Each longitudinally-extending side 404 has a length of about 11.5 inches, and each laterally-extending side 405 has a length of about five inches such that the total perimeter of the cutting device 402 is about 33 inches. Each of the discontinuities 406 has a length of about half an inch. Thus, the total length of the discontinuities 406 (i.e., about one inch) is less than 10% of the total perimeter of the cutting device 402, and in the illustrated form is about 3% of the total perimeter of the cutting device 402.

FIG. 11 illustrates a sample cutter 410 according to certain embodiments. The sample cutter 410 includes a base plate 411 and a cutting device 412 extending from the base plate 411. The cutting device 412 includes at least one blade 413, the at least one blade 413 defining a pair of longitudinally-extending sides 414 and a pair of laterally-extending sides 415. At least one discontinuity 416 is formed in the cutting device 412, and in the illustrated form three discontinuities 416 are formed in one of the longitudinally-extending sides 414. One of the discontinuities 416 is formed at a central location of the one longitudinally-extending side 414, and the other two discontinuities 416 are evenly spaced from the central discontinuity 416 and positioned on opposite sides of the central discontinuity 416. Each longitudinally-extending side 414 has a length of about 11.5 inches, and each laterally-extending side 415 has a length of about five inches such that the total perimeter of the cutting device 412 is about 33 inches. Each of the discontinuities 416 has a length of about half an inch. Thus, the total length of the discontinuities 416 (i.e., about 1.5 inches) is less than 10% of the total perimeter of the cutting device 412, and in the illustrated form is about 4.5% of the total perimeter of the cutting device 412.

FIG. 12 illustrates a sample cutter 420 according to certain embodiments. The sample cutter 420 includes a base plate 421 and a cutting device 422 extending from the base plate 421. The cutting device 422 includes at least one blade 423, the at least one blade 423 defining a pair of longitudinally-extending sides 424 and a pair of laterally-extending sides 425. At least one discontinuity 426 is formed in the cutting device 422, and in the illustrated form a single discontinuity 426 is formed at a central location of one of the longitudinally-extending sides 424. Each longitudinally-extending side 424 has a length of about 11.5 inches, and each laterally-extending side 425 has a length of about five inches such that the total perimeter of the cutting device 422 is about 33 inches. The discontinuity 426 has a length of about half an inch. Thus, the total length of the discontinuity 426 (i.e., about half an inch) is less than 10% of the total perimeter of the cutting device 422, and in the illustrated form is about 1.5% of the total perimeter of the cutting device 422.

FIG. 13 illustrates a sample cutter 430 according to certain embodiments. The sample cutter 430 includes a base plate 431 and a cutting device 432 extending from the base plate 431. The cutting device 432 includes at least one blade 433, the at least one blade 433 defining a pair of longitudinally-extending sides 434 and a pair of laterally-extending sides 435. At least one discontinuity 436 is formed in the cutting device 432, and in the illustrated form a pair of discontinuities 436 are formed in the cutting device 432. More particularly, each of the two discontinuities 436 is formed at a central location of a corresponding one of the longitudinally-extending sides 434. Each longitudinally-extending side 434 has a length of about 11.5 inches, and each laterally-extending side 435 has a length of about five inches such that the total perimeter of the cutting device 432 is about 33 inches. Each of the discontinuities 436 has a length of about half an inch. Thus, the total length of the discontinuities 436 (i.e., about one inch) is less than 10% of the total perimeter of the cutting device 432, and in the illustrated form is about 3% of the total perimeter of the cutting device 432.

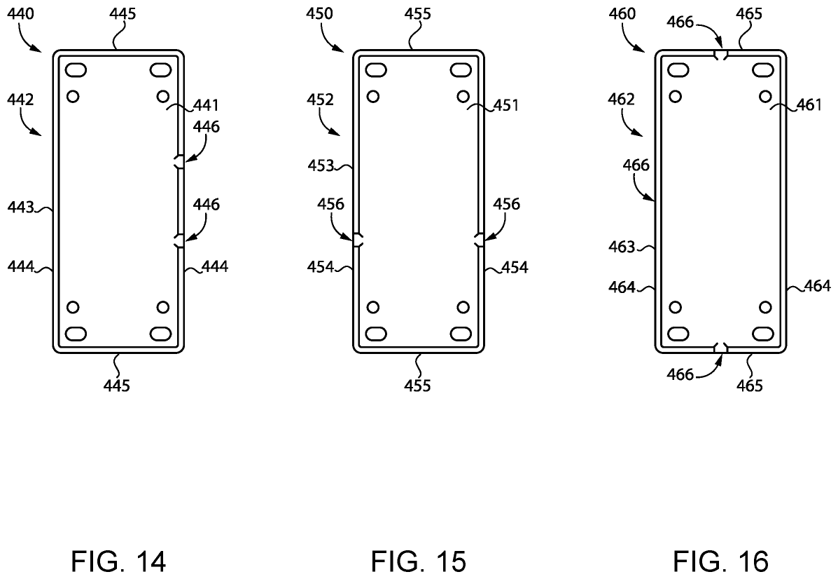

FIG. 14 illustrates a sample cutter 440 according to certain embodiments. The sample cutter 440 includes a base plate 441 and a cutting device 442 extending from the base plate 441. The cutting device 442 includes at least one blade 443, the at least one blade 443 defining a pair of longitudinally-extending sides 444 and a pair of laterally-extending sides 445. At least one discontinuity 446 is formed in the cutting device 442, and in the illustrated form two discontinuities 446 are formed in one of the longitudinally-extending sides 444 at locations offset from the center of the longitudinally-extending side 444. Each longitudinally-extending side 444 has a length of about 11.5 inches, and each laterally-extending side 445 has a length of about five inches such that the total perimeter of the cutting device 442 is about 33 inches. Each of the discontinuities 446 has a length of about half an inch. Thus, the total length of the discontinuities 446 (i.e., about one inch) is less than 10% of the total perimeter of the cutting device 442, and in the illustrated form is about 3% of the total perimeter of the cutting device 442.

FIG. 15 illustrates a sample cutter 450 according to certain embodiments. The sample cutter 450 includes a base plate 451 and a cutting device 452 extending from the base plate 451. The cutting device 452 includes at least one blade 453, the at least one blade 453 defining a pair of longitudinally-extending sides 454 and a pair of laterally-extending sides 455. At least one discontinuity 456 is formed in the cutting device 452, and in the illustrated form one discontinuity 456 is formed in each of the longitudinally-extending sides 454 at a location offset from the center of the corresponding longitudinally-extending side 454. Each longitudinally-extending side 454 has a length of about 11.5 inches, and each laterally-extending side 455 has a length of about five inches such that the total perimeter of the cutting device 452 is about 33 inches. Each of the discontinuities 456 has a length of about half an inch. Thus, the total length of the discontinuities 456 (i.e., about one inch) is less than 10% of the total perimeter of the cutting device 452, and in the illustrated form is about 3% of the total perimeter of the cutting device 452.

FIG. 16 illustrates a sample cutter 460 according to certain embodiments. The sample cutter 460 includes a base plate 461 and a cutting device 462 extending from the base plate 461. The cutting device 462 includes at least one blade 463, the at least one blade 463 defining a pair of longitudinally-extending sides 464 and a pair of laterally-extending sides 465. At least one discontinuity 466 is formed in the cutting device 462, and in the illustrated form one discontinuity 466 is formed in each of the laterally-extending sides 465. Each longitudinally-extending side 464 has a length of about 11.5 inches, and each laterally-extending side 465 has a length of about five inches such that the total perimeter of the cutting device 462 is about 33 inches. Each of the discontinuities 466 has a length of about half an inch. Thus, the total length of the discontinuities 466 (i.e., about one inch) is less than 10% of the total perimeter of the cutting device 462, and in the illustrated form is about 3% of the total perimeter of the cutting device 462.

While the discontinuities in the sample cutters illustrated in FIGS. 10-16 each have a discontinuity dimension of about half an inch, it is also contemplated that other discontinuity dimensions may be utilized, such as a quarter inch, three eights of an inch, three quarters of an inch, or one inch. For example, if the discontinuities 426 of the sample cutter 420 were provided with a dimension of about one inch, the total length of the three discontinuities (i.e., about three inches) would be about 9% of the total perimeter of the cutting device 422.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A sample cutter for preparing a sample of fibrous material, the sample cutter comprising:
a base plate; and
a cutting mechanism extending from the base plate, the cutting mechanism including at least one blade and at least one discontinuity, the at least one discontinuity having a total length less than 10% of a total perimeter of the cutting mechanism.

2. The sample cutter of claim 1, wherein the at least one blade partially defines a geometric shape.

3. The sample cutter of claim 2, wherein the geometric shape is a polygon comprising a plurality of sides.

4. The sample cutter of claim 3, wherein a discontinuity of the at least one discontinuity is defined at a center of one of the sides.

5. The sample cutter of claim 3, wherein each of the sides has a corresponding and respective side dimension; and
wherein each discontinuity has a discontinuity dimension less than each side dimension.

6. The sample cutter of claim 3, wherein the polygon is rectangular;
wherein the plurality of sides comprises a pair of longitudinally-extending sides and a pair of laterally-extending sides extending between and connecting the pair of longitudinally-extending sides; and
wherein each longitudinally-extending side is longer than each laterally-extending side.

7. The sample cutter of claim 1, wherein the at least one blade entirely encloses a sample area but for the at least one discontinuity.

8. The sample cutter of claim 1, wherein the total length of the at least one discontinuity is less than 5% of the total perimeter of the cutting mechanism.

9. A method of utilizing the sample cutter of claim 1, the method comprising:
pressing the sample cutter into a mass of fibrous material to thereby prepare a sample from the mass of fibrous material;
wherein the sample remains connected to the mass via at least one connection area corresponding to the at least one discontinuity.

10. The method of claim 9, further comprising pneumatically removing the sample from the mass of fibrous material.

11. A sample cutter for preparing a sample of fibrous material, the sample cutter comprising:
a base plate; and
a cutting mechanism extending from the base plate, the cutting mechanism comprising a plurality of blades, the plurality of blades comprising:
a pair of longitudinal blades, each longitudinal blade having a corresponding first end and a corresponding second end;
a first lateral blade extending between the first ends of the longitudinal blades; and
a second lateral blade extending between the second ends of the longitudinal blades;
wherein each blade of the plurality of blades has a corresponding and respective cutting edge; and
wherein the second lateral blade comprises a discontinuity in the cutting edge thereof.

12. The sample cutter of claim 11, wherein the discontinuity is defined at a center of the second lateral blade.

13. The sample cutter of claim 11, wherein the first lateral blade is joined with the first ends of the longitudinal blade to define corners of the cutting mechanism.

14. The sample cutter of claim 13, wherein the corners are rounded.

15. The sample cutter of claim 11, wherein a length of the discontinuity is less than one half a length of the second lateral blade.

16. A method of utilizing the sample cutter of claim 11, the method comprising:
pressing the sample cutter into a mass of fibrous material to thereby prepare a sample from the mass of fibrous material;
wherein the sample remains connected to the mass of fibrous material at a connection area corresponding to the discontinuity.

17. The method of claim 16, further comprising removing the sample from the mass of fibrous material by directing a burst of air at the sample.

18. The method of claim 16, wherein the connection area is formed along a centerline of a face of the mass of fibrous material.

19. A sample cutter for preparing a sample of fibrous material, the sample cutter comprising:
a base plate; and
a cutting mechanism extending from the base plate, the cutting mechanism comprising a plurality of blades arranged in a shape of a polygon;
wherein one of the blades corresponds to a side of the polygon and comprises a discontinuity;
wherein a length dimension of the discontinuity is less than a length of the corresponding side of the polygon.

20. The sample cutter of claim 19, wherein the polygon is a rectangle.

21. The sample cutter of claim 19, wherein each of the blades other than the one blade is continuous to fully define a corresponding and respective side of the polygon.

22. The sample cutter of claim 19, wherein each blade meets an adjacent blade at a corresponding and respective corner.

23. The sample cutter of claim 22, wherein each corner is rounded.

24. The sample cutter of claim 19, wherein the length dimension of the discontinuity is less than one half the length of the corresponding side of the polygon.

25. The sample cutter of claim 19, wherein the discontinuity is defined at a center of the corresponding side of the polygon.

26. A method of utilizing the sample cutter of claim 19, the method comprising:
pressing the sample cutter into a mass of fibrous material to thereby prepare a sample from the mass of fibrous material;
wherein the sample remains connected to the mass of fibrous material at a connection area corresponding to the discontinuity.
